(19) United States
(12) Patent Application Publication
(10) Pub. No.: US 2008/0007788 A1
(43) Pub. Date: Jan. 10, 2008

(54) Smart page photo sizing, composing and cropping tool

(76) Inventors: Frederick L. Good, Cambridge, MA (US); Thuy Tu Pham, Norwood, MA (US); Craig A. Stuber, Brentwood, NH (US)

Correspondence Address: KRAMER & AMADO, P.C., 1725 DUKE STREET, SUITE 240, ALEXANDRIA, VA, 22314, US

(21) Appl. No.: 11/819,830

(22) Filed: Jun. 29, 2007

Related U.S. Application Data
(60) Provisional application No. 60/817,357, filed on Jun. 30, 2006.

(51) Int. Cl. H04N 1/23

(52) U.S. Cl. 358/302

(57) ABSTRACT

The present invention generally relates to systems, methods and computer applications for the management of photos. The present invention preferably includes a photo manager comprising an image editor, a resize tool and a cropping tool. The image editor preferably has a defined boundary and is superimposable and movable over a photo. The resize tool preferably provides for resizing at least a section of the photo within the defined boundary of the image editor. The cropping tool preferably provides for cropping the photo as defined by the boundary of the image editor.

This application claims priority to Provisional Application Ser. No. 60/817,357 filed on Jun. 30, 2006, the contents of which are incorporated herein in their entirety.

### FIELD OF THE INVENTION

The present invention generally relates to the management of photos and other images.

### BACKGROUND OF THE INVENTION

The Internet today includes millions of web sites hosted on servers around the world. Each website consists of various pages, related or not, that are linked together in various manners to other pages within the same site or to other sites. Websites are created for distributing information, advertising, selling or buying goods and services, and expressing ones' creative nature.

Websites include a variety of pages so as to improve communication with the viewer. Websites commonly include pages containing graphic displays for attracting the viewer's attention, simple text pages for quick and effective communication of information, ecommerce pages for the selling of goods and services, web forms and a variety of other pages. Photos and other images are commonly included within a website not only to attract the viewers' attention, but as an effective way in which to communicate with viewers. Moreover, individuals and businesses are increasingly turning to the use of digital photos and images often storing and managing them online. As a result, website users and developers are faced with an increasing number of new and complex problems. For example, in addition to online storage, users are becoming accustomed to providing others with digital copies of their photos, whether via email or other means of communication. As a result, more and more websites and computer programs are providing users with photo management capabilities including, but not limited to, the ability to upload, store, manipulate, tag and forward photos and other images. Furthermore, as online and offline digital photo management gains in popularity, the number of features offered to users will only increase. However, as the capabilities of photo management systems increase, not only will the complexity of providing such capabilities increase, but users' expectations will also increase with respect to available features and their ease of use, especially in the online environment.

Nevertheless, traditional website and photo build and management techniques are inconsistent with users' expectations. For example, websites have been traditionally created using simple text editing software. This ‘do-it-yourself’ development environment requires the designer to know a plethora of hypertext markup language symbols and techniques that are beyond the skill and interests of an average computer user. The storage, display and management of photos and other images only increases the necessary skill level.

However, nowadays more sophisticated web designing tools are available for the creation of websites. This component development environment provides the professional designer with the ability to create complex websites. These websites might enable and/or require the integration of modules for ecommerce, data entry, web statistics, site security, video, downloads, forms, photo/image management and others. To further complicate matters, the professional must also deal with website support services such as hosting, domain name, bandwidth, storage and email.

These two web and photo design/management approaches are mastered through lots of training and skill. These tools are geared towards power users and fundamentally fail to guide a user through the simplest of tasks. This lack of guidance not only makes it difficult for the user to create, upload and maintain the simplest text pages, but the creation and management of more complex pages such as those containing digital photo pages is simply beyond the capabilities of most users. For instance, for most individuals the process of uploading a photo from their digital camera to their computer or a website is a daunting experience. Once loaded, however, the complexity only increases. Not only is the individual faced with numerous creative and technical decisions including, but limited to, photo storage, size, display and manipulation, but the skill level required to implement these decisions remains high.

Despite the problems discussed above, little guidance is available to the user regarding photo management. Some efforts have been made to provide the user with cropping and resize capabilities, but such tools are typically provided as separate tools which require the user to learn separate sets of skills for each tool. Even if the user is able to modify the size and look of a photo, the user is still faced with the technical problem of how to load the modified photo onto a desired page. Moreover, once loaded to a page, the user must learn how to position the photo within the page, which can be especially daunting if the user desires to load multiple photos. Such problems leave the user with limited capabilities creativity and control over the management of their photos and other images.

Accordingly, there is a need for improved photo management tools and methods which allow the user to effectively store, manipulate and display their photos, without overwhelming the user with complexity. Furthermore, as users increasingly turn to the Internet, there is a special need for improved photo management tools and methods in the online environment.

### SUMMARY OF THE INVENTION

According to a preferred embodiment, the present invention generally relates to methods of managing photos, comprising: providing a user interface comprising a photo manager, the photo manager comprising an image editor, the image editor having a defined boundary; superimposing the image editor over at least a section of a photo; and resizing at least a portion of the photo within the defined boundary of the image editor.

According to another preferred embodiment, the present invention generally relates to photo management systems, said photo management system comprising: a photo manager comprising an image editor and a resize tool; the image editor having a defined boundary and superimposable over a photo; and a resize tool providing for resizing at least a section of the photo within the defined boundary of the image editor.

According to another preferred embodiment, the present invention generally relates to computer readable storage medium on which is embedded one or more computer programs, the one or more computer programs implementing a method for managing photos, the one or more computer programs comprising a set of instructions for: providing a user interface comprising a photo manager, the photo manager comprising an image editor, the image editor having a defined boundary; superimposing the image editor over at least a portion of a photo; and resizing at least a section of the photo within the defined boundary of the image editor.

According to another preferred embodiment, the present invention generally relates to photo management systems, said systems comprising: a first user interface for providing the user with a layout, wherein said layout comprises at least one photo box for the placement of at least one photo; a second user interface for providing the user with a photo manager, wherein said photo manager is accessible via said photo box.

According to a further preferred embodiment, the present invention generally relates to methods of managing photos, said methods comprising: providing a user interface comprising a layout, wherein said layout comprises at least one photo box for the placement of at least one photo; accessing a photo manager via said photo box; and providing the photo manager within a user interface.

### BRIEF DESCRIPTION OF THE DRAWINGS

Examples of the invention are illustrated, without limitation, in the accompanying figures in which like numeral references refer to like elements, and wherein:

FIG. 1 shows an interface for providing a layout with a plurality of photo boxes and text boxes, in accordance with a preferred embodiment of the present invention.

FIG. 2 shows an interface for providing a photo manager, in accordance with a preferred embodiment of the present invention.

FIG. 3 shows an interface for providing a photo manager, in accordance with a preferred embodiment of the present invention.

FIG. 4 shows an interface for providing a photo manager, in accordance with another preferred embodiment of the present invention.

FIG. 5 shows an interface for providing a photo manager, in accordance with another preferred embodiment of the present invention.

FIG. 6 shows an interface for providing photo manager, in accordance with another preferred embodiment of the present invention.

FIG. 7 shows an interface for providing a layout, in accordance with a preferred embodiment of the present invention.

FIG. 8 shows an interface for providing photo manager, in accordance with a preferred embodiment of the present invention.

FIG. 9 shows an interface for providing photo manager, in accordance with another preferred embodiment of the present invention.

FIG. 10 shows an interface for providing photo manager, in accordance with another preferred embodiment of the present invention.

FIG. 11 shows an interface for providing a layout, in accordance with a preferred embodiment of the present invention.

FIG. 12 shows an interface for providing photo manager, in accordance with a preferred embodiment of the present invention.

FIG. 13 shows an interface for providing photo manager, in accordance with another preferred embodiment of the present invention.

FIG. 14 shows an interface for providing a managed photo, in accordance with another preferred embodiment of the present invention.

FIG. 15 shows a technical design, in accordance with a preferred embodiment of the present invention.

FIG. 16 shows a photo box, in accordance with a preferred embodiment of the present invention.

FIG. 17 shows a block diagram of a computer system wherein preferred embodiments of the present invention may be implemented.

### DETAILED DESCRIPTION OF THE PREFERRED EMBODIMENTS

For simplicity and illustrative purposes, the principles are shown by way of examples of systems and methods described. In the following description, numerous specific details are set forth in order to provide a thorough understanding of the examples. It will be apparent however, to one of ordinary skill in the art, that the examples may be practiced without limitation to these specific details. In other instances, well known methods and structures are not described in detail so as not to unnecessarily obscure understanding of the examples.

The present invention relates to systems, methods, and/or computer software applications for the management of photos and other images, in particular digital photos and images. The systems, methods and/or applications of the present invention preferably provide the user with at least one interface 100 through which a layout 110 (or design) of a page for displaying photos (e.g., web page) may be selected or created by the user. The systems, methods and/or applications of the present invention preferably allow the user to provide for at least one photo within the layout 110. The systems, methods and/or applications of the present invention preferably allow a user to manage photos and other images via a photo manager 200 comprising photo management tools. Preferably, the photo manager 200 comprises an image editor 210 having integrated photo composing, resizing and cropping functionality. Preferably, the photo manager 200 comprises an image editor 210, photo resize tool 220 and/or photo cropping tool 230. Preferably, the image editor 210 comprises a photo resize tool 220 and/or a photo cropping tool 230. As discussed in detail below, those of ordinary skill in the art will recognize that through the use of the present invention, preferably the photo manager 200 and/or image editor 210, the user is provided with improved and simplified techniques for the management of photos and other images.

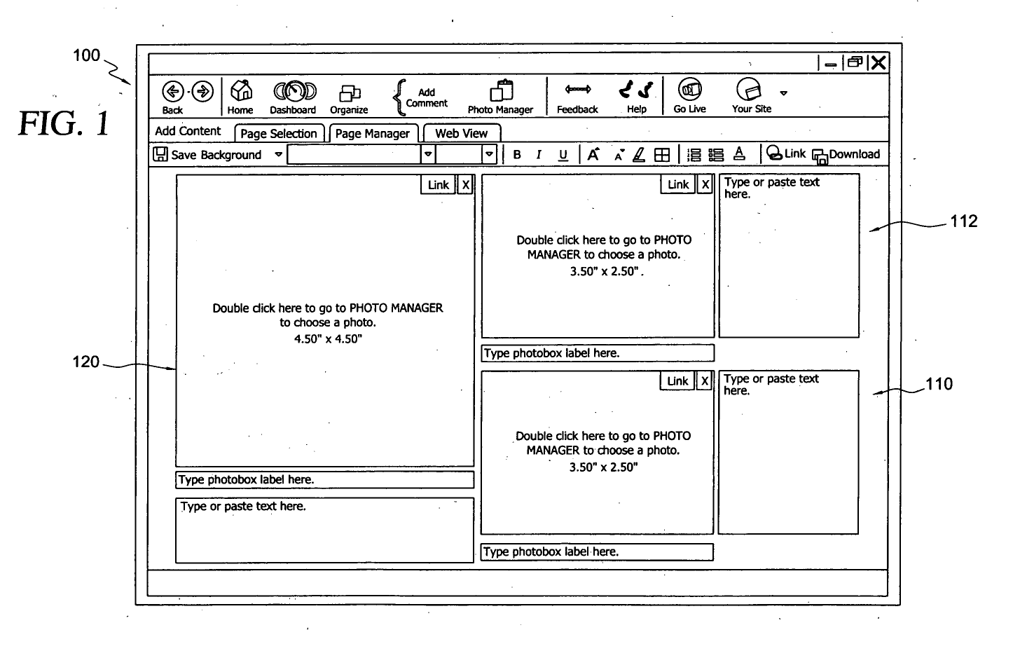

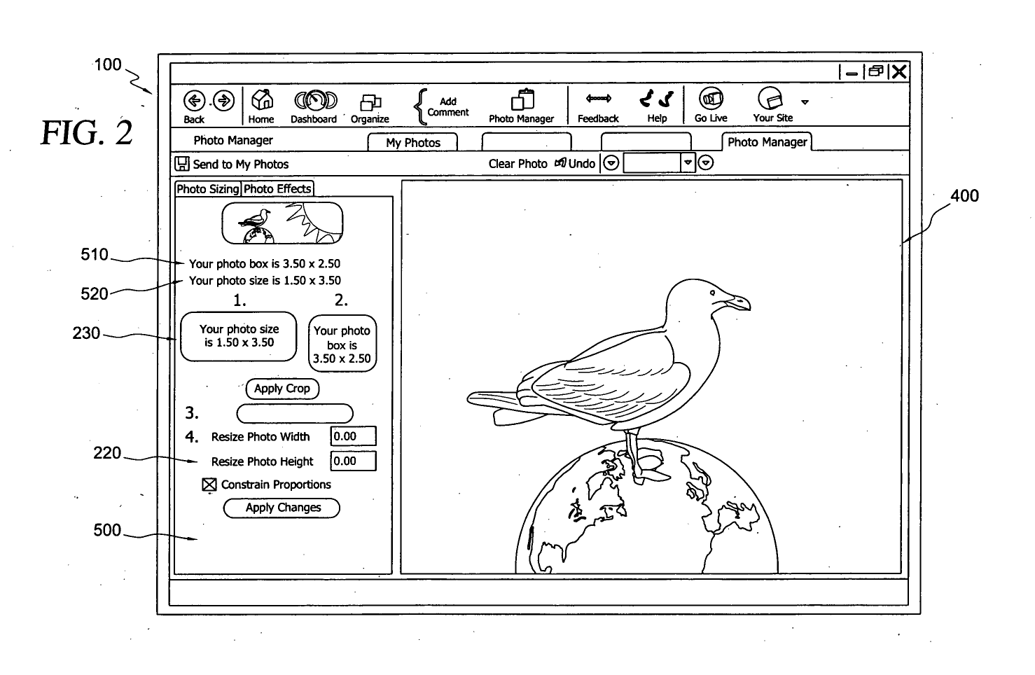

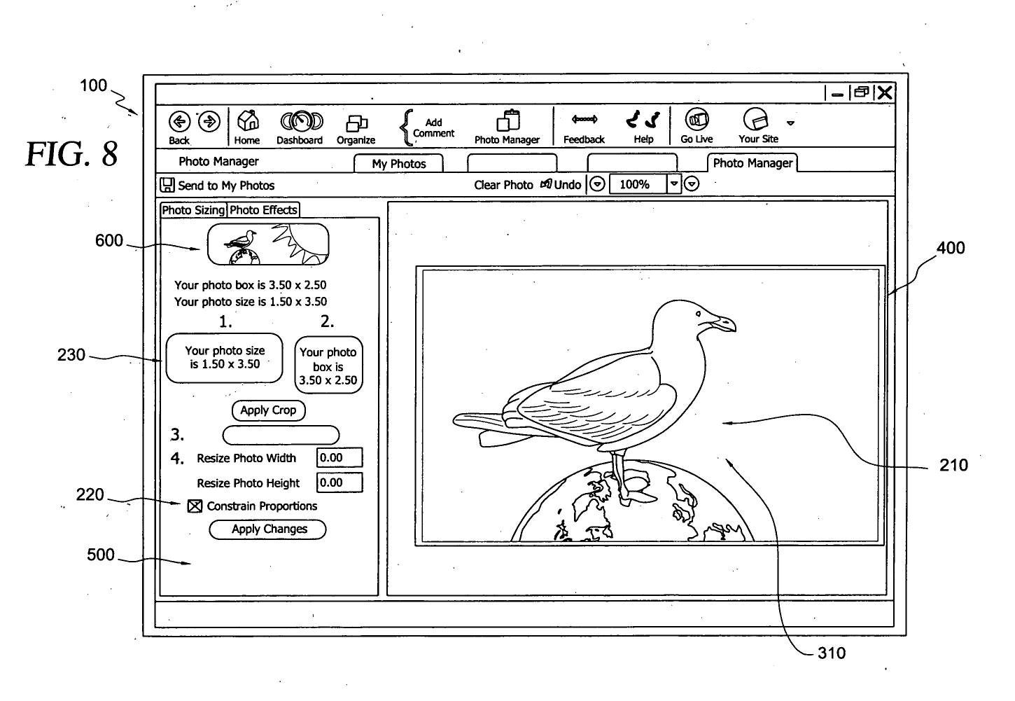

Throughout the present disclosure, reference is made to an interface 100 or user interface 100. An interface 100 is a tool through which the user may interact with any element(s) of the present invention. Preferably, the interface 100 is a screen within a computer application for interaction with elements of the present invention. More preferably, the interface 100 is a screen displayed within a web browser for interaction with elements of the present invention. In one example, the interface 100 is a screen through which the user may select or create a layout 110 for a photo page, for instance as illustrated in FIGS. 1 and 8. In another example, the interface 100 is a screen through which the user may interact with the photo manager 200, image editor 210, resize tool 220 and/or cropping tool 230 as illustrated for instance in FIGS. 2-6. Those of ordinary skill in the art will recognize that an interface 100 may be embodied by a computer program or a plurality of computer programs, which may exist in a variety of forms both active and inactive in a single computer system or across multiple computer systems, both online and offline.

Those of ordinary skill in the art will recognize that the present invention generally relates to improved systems, methods and/or computer applications for the management of photos and other images, in particular digital photos on a web page or website. Through the present invention, the user with limited knowledge of computer software, web design or even the photographic arts may effectively manage their photos, including the loading, modifying and/or displaying their photos, within an online or offline environment.

In one example, the present invention relates to methods of managing photos. The methods of the present invention preferably include providing a user interface 100 comprising a photo manager 200. The photo manager 200 preferably comprises an image editor 210, wherein the image editor 210 has a defined boundary 310. The methods preferably include superimposing the image editor 210 over at least a section of a photo. The methods also preferably include resizing at least a portion of the photo within the defined boundary 310 of the image editor 210. Preferably, the methods include moving the image editor 210 over the photo so that a desired section of the photo rests within the defined boundary 310 of the image editor. Preferably, the methods include cropping the photo as defined by the boundary 310 of the image editor 210.

In another example, the present invention relates to photo management systems. The systems of the present invention preferably include a photo manager 200 comprising an image editor 210. The systems of the present invention preferably include a photo manager 200 comprising a photo resize tool 220. The image editor 210 preferably has a defined boundary 310. The image editor 210 is preferably superimposable over a photo. The systems of the present invention preferably include a photo resize tool 220 providing for resizing at least a section of the photo within the defined boundary 310 of the image editor 210. Preferably, the systems of the present invention include the image editor 210 being movable over the photo so that a desired section of the photo rests within the defined boundary 310 of the image editor 210. Preferably, the systems include a cropping tool 230 for cropping the photo as defined by the boundary 310 of the image editor 210.

In another example, the present invention relates to computer readable storage medium on which is embedded one or more computer programs. Preferably, the one or more computer programs implement a method for managing photos. More preferably, the one or more computer programs include a set of instructions for providing a user interface 100 comprising a photo manager 200. The photo manager preferably includes an image editor 210, wherein the image editor 210 has a defined boundary 310. Preferably, the one or more computer programs include a set of instructions for superimposing the image editor 210 over at least a portion of a photo. Preferably, the one or more computer programs include a set of instructions for resizing at least a section of the photo within the defined boundary 310 of the image editor 210. Preferably, the one or more computer programs include a set of instructions for moving the image editor 210 over the photo so that a desired section of the photo rests within the defined boundary 310 of the image editor 210. Preferably, the one or more computer programs include a set of instructions for cropping the photo as defined by the boundary 310 of the image editor 210.

In another example, the present invention relates to methods of managing photos, wherein said methods include providing a user interface 100 comprising a layout 110, wherein said layout 110 comprises at least one photo box 120 for the placement of at least one photo; accessing a photo manager 200 via said photo box 120; and providing the photo manager 200 within a user interface 100. Preferably, the methods include the photo manager 200 comprising an image editor 210, the image editor 210 having a defined boundary 310; superimposing the image editor 210 over at least a portion of a photo; and resizing at least a section of the photo within the defined boundary 310 of the image editor 210. Preferably, the methods include moving the image editor 210 over the photo so that a desired section of the photo rests within the defined boundary 310 of the image editor 210.

In another example, the present invention relates to photo management systems, wherein the systems include a first user interface 100 for providing the user with a layout 110, wherein said layout 110 comprises at least one photo box for the placement of at least one photo; and a second user interface 110 for providing the user with a photo manager 200, wherein said photo manager 200 is accessible via said photo box 120. Preferably, the systems include the photo manager 200 comprising an image editor 210; the image editor 210 having a defined boundary 310 and superimposable over a photo; and a resize tool 220 providing for resizing at least a section of the photo within the defined boundary 310 of the image editor 210. Preferably, the systems include the image editor 210 movable over the photo so that a desired section of the photo rests within the defined boundary 310 of the image editor 210. Preferably, the systems include a cropping tool 230 for cropping the photo as defined by the boundary 310 of the image editor 210.

In view of the examples described herein, those of ordinary skill in the art will recognize that the present invention preferably includes a photo manager 200. The photo manager 200 preferably includes tools for composing, resizing and/or cropping photos. The photo manager 20 preferably includes the image editor 210. The photo manger 200 preferably includes the photo resize tool 220 or photo cropping tool 230. In one example, the photo manager 200 is accessed by a photo box 120 provided in a layout 110. The photo manager 200 is preferably provided in a user interface 100, through which a user interacts with the photo manger 200. Those of ordinary skill in the art will recognize that the photo manager 200 allows for the management of photos including, but not limited to, composing, sizing or resizing, cropping and/or displaying photos. It will be appreciated that the photo manager 200 may greatly enhances a user's capabilities to manager and display photos, whether online or offline.

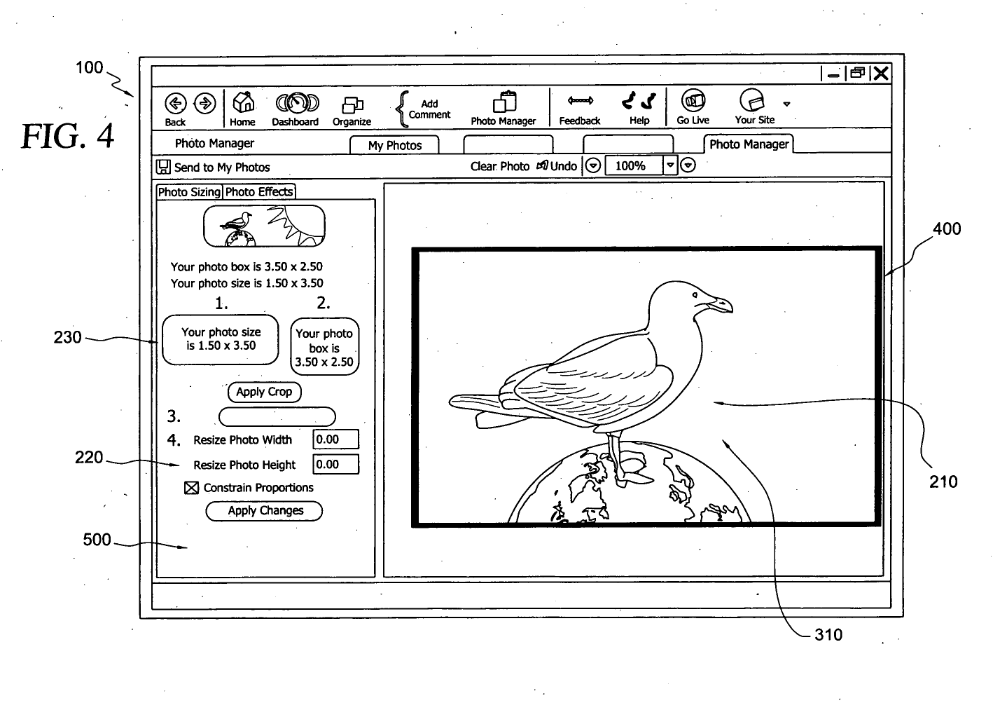

Those of ordinary skill in the art will recognize that the present invention preferably includes an image editor 210. Preferably, the image editor 210 has a defined boundary 310. For example, as illustrated in FIG. 4, the image editor 210 is provided as a square box, wherein the outer edges of the box form the defined boundary 310. In another example, the image editor 210 may be provided as a circle, wherein the outer circumference of the circle forms the defined boundary 310. In other words, those of ordinary skill in the art will recognize that the image editor 210 and its defined boundary 310 may be provided as a variety of configurations, whether a square, rectangle, circle, triangle or other. Those of ordinary skill in the art will recognize that the area within the defined boundary 310 preferably forms a preferred working area for a photo, wherein the photo may be composed, sized or resized, cropped or worked with a tool for photo management. In one example, the size and/or shape of the defined boundary 310 is determined by the size of the photo box 120 through which the photo manager 200 is accessed. Yet, preferably the size (and/or shape) of the defined boundary 310 may be modified or changed by the user. In another example, rather than the size and/or shape of the defined boundary 310 being determined by a photo box 120, the present invention allows the user to determine the size and/or shape of the defined boundary 310, for instance through the use of controls within the photo manager 200.

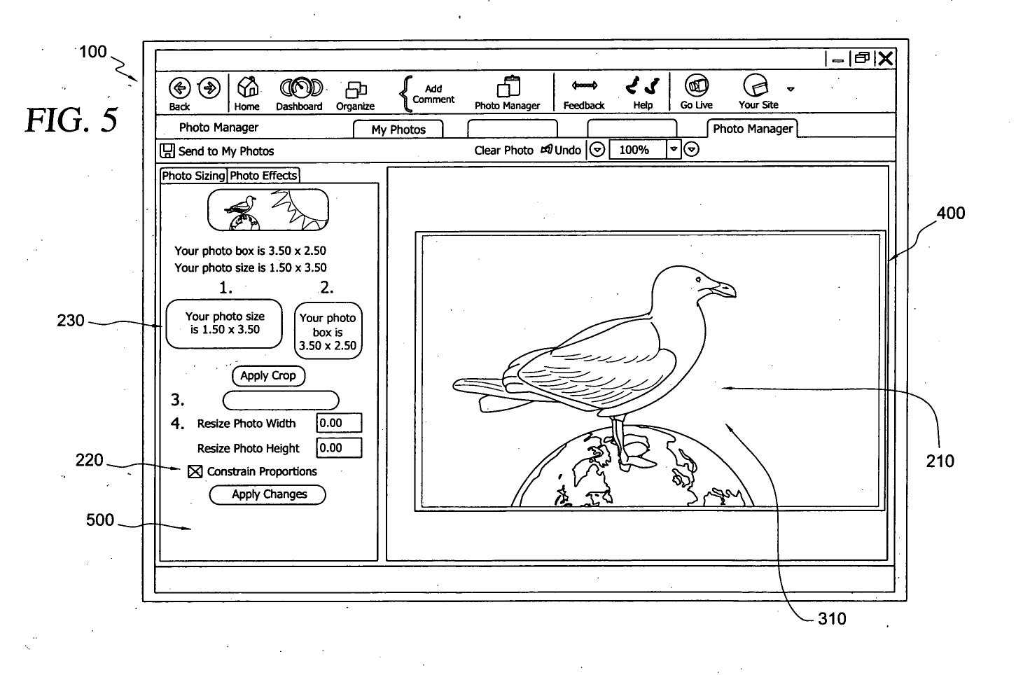

Preferably, the image editor 210 may be superimposed over a photo. That is, the image editor 210 is preferably superimposable, more preferably superimposable on a photo. For example, as illustrated in at least FIGS. 4 and 5, the image editor 210 is superimposed over a photo. A section of the photo rests or remains within the defined boundary 310 of the image editor 210, so as to provide a preferred section of the photo to be managed. However, it should be recognized that the section(s) of the photo that remain outside the defined boundary 310 may also be managed. Preferably such section(s) may be resized, but more preferably the sections of the photo within and without the defined boundary 310 may be resized. In fact, in accordance with the preferred embodiments of the present invention, the photo manager 200 allows the user to manager the entire photo, while preferably managing the section of photo that rests or remains within the defined boundary 310 of the image editor 210. In one example, the entire photo may be resized so that the entire photo fits within the defined boundary 310 of the image editor 210. In another example, the photo may be resized so that the section of the photo already within the defined boundary 310 is provided with a desired arrangement or fit within the defined boundary 310.

Preferably, the image editor 210 is movable over a photo. More preferably, the image editor 210 may be moved over a photo so that any section of the photo may rest or remain within the defined boundary 310 of the image editor 210. For example, as illustrated in FIGS. 4 and 5, the image editor 210 may be moved over the photo so as to fit as much as possible of an image (e.g., the seagull) within the defined boundary 310 of the image editor 210. In another example, however, the image editor 210 may be moved so that any desired section of a photo rests within the defined boundary 310 of the image editor 210. In other words, in that the image editor 210 is movable, those of ordinary skill in the art will recognize that the image editor 210 may be superimposed over any section of the photo a user desires.

In view of the examples described herein, those of ordinary skill in the art will recognize that the present invention preferably includes a photo resize tool 220. Preferably, a photo resize tool 220 may be included as part of the photo manager 200. A photo resize tool 220 and its function, in accordance with the preferred embodiments of the present invention, may be described below, with reference to the drawings. Those of ordinary skill in the art will recognize that the photo resize tool 220 preferably also includes controls for its operation by a user, as also described below.

In view of the examples described herein, those of ordinary skill in the art will also recognize that the present invention preferably includes a photo cropping tool 230. Preferably, a photo crop tool 230 may be included as part of the photo manager 200. A photo crop tool 230 and its function, in accordance with the preferred embodiments of the present invention, may be described below, with reference to the drawings. Those of ordinary skill in the art will recognize that the photo crop tool 230 preferably also includes controls for its operation by a user, as also described below.

In one example of the preferred embodiments of the present invention, an interface 100 provides the user with at least one layout 110, wherein the layout 110 includes at least one (or a plurality) photo box 120, for instance as illustrated by FIG. 1. However, those of ordinary skill in the art will recognize that the user may also be preferably provided with the capability of creating a “custom” layout 110. That is, in accordance with preferred embodiments of the present invention, the user may be provided with an empty layout 110 along with the means for locating desired content areas, particularly photo boxes 120, within the layout 110 wherever the user so chooses. Those of ordinary skill in the art will recognize that the user may be provided with a variety of means for customizing a layout 110, such as a control tool located within a tool bar. Those of ordinary skill in the art will also recognize that a control tool may be in the form of various preferred embodiments, for instance a drawing tool or a select-and-drag tool which allows the user with the option of drawing or selecting-and-dragging a photo box 120 within a layout 110 in a “custom” configuration.

As illustrated in FIGS. 1 and 2, the photo manager 200 is preferably accessed via the photo box 120. Preferably, the user accesses the photo manager 200 by clicking (e.g., with a computer mouse) on a photo box 120. Preferably, through the photo box 120, the user may load a photo or image within the photo manager 200 for photo management. Preferably, the user places a photo or image within the photo manager 200 by clicking (e.g., with a computer mouse) on the photo box 120. Those of ordinary skill in the art will recognize that the photo may be preferably stored in a photo library, for example a computer hard drive or other electronic medium, wherein clicking on a photo box 120 provides the user with the option of selecting a desired stored photo from the photo library and loading the selected photo into the photo manager 200.

In another example, an interface 100 provides the user with a photo manager 200 which includes photo management capabilities. For example, the photo manager 200 may include an image editor 210, photo resize tool 220, photo crop tool 230 and/or other tools for the management of photos and other images. Those of ordinary skill in the art will recognize that such photo management tools need not be separate and independent tools, but rather may be integrated. That is, any combination or even all photo management tools may be included as part of a single element (e.g., tool) of the present invention, for instance a single element (e.g., tool) included within the photo manager 200. In one example, as illustrated in FIGS. 2-6, 8-9 and 12, the photo manager 200 preferably includes an image editor 210 which may be superimposed over a photo loaded into the photo manager 200. Preferably, the user moves the image editor 210 over the photo so that the desired section of the photo remains within the defined boundary 310 of the image editor 210. Those of ordinary skill in the art will recognize that a number of tools for moving the image editor 210 may be provided, for instance a computer mouse. Preferably, the photo may be resized so as to better fit within the image editor 210. Furthermore, the photo may be preferably cropped as defined by the boundary 310 of the image editor 210. That is, the photo may be cropped so that only the section within the defined boundary 310 remains (and thereafter may be placed within the photo box 120 of the layout 110).

Those of ordinary skill in the art will recognize that the preferred embodiments of the present invention, as discussed herein with reference to figures and examples, encompass systems methods and/or computer programs through which a user manages photos and other images. Those of ordinary skill in the art will recognize that the photo management capabilities of the present invention preferably include, but are not limited to, the selecting, composing, sizing or resizing, cropping and/or displaying of photos and images.

As illustrated in FIG. 1, an interface 100 provides the user with a layout 110 for the display of photos and other images. In one example, an interface 100 may allow the user to create a desired layout 110. In another embodiment, the interface 100 may include at least one prescribed layout, wherein the user selects a layout 110 from those provided. As shown in FIG. 1, the layout may include at least one photo box 120, preferably a plurality of photo boxes of varying size. The layout may also include at least one text box 112 or boxes in which the user may enter (e.g., type of paste) and display text. Preferably, a photo manager 200 is accessed via a photo box 120, preferably by clicking (e.g., with a computer mouse) on the photo box. For instance, clicking on a photo box 120 may provide the user with the option of selecting a desired stored photo from the photo library and loading the selected photo into the photo manager 200. Those or ordinary skill in the art will recognize that the layout 110 preferably provides the user with a layout 110 for the display of photos and/or other images, preferably the display of photos on a page, more preferably a web page.

As illustrated in FIG. 2-14, an interface 100 provides access to the photo manager 200, which is preferably accessed via a photo box 120 as shown in FIG. 1. In one example, as shown in FIG. 2, the photo manager 200 comprises a main photo area 400 for display of a photo or image and a tool area 500 comprising photo management tools and/or controls for photo management tools. Preferably, a photo is loaded and displayed within the main photo area 400 from a photo library or a photo storage medium. Those of ordinary skill in the art will recognize that the photo library or photo storage medium may take a variety of forms including, but not limited to, a hard drive located on a computer or elsewhere. In a preferred embodiment, as shown in FIG. 2, the tool area 500 includes controls 1, 2, 3, 4 for the image editor 210, resize tool 220 and crop tool 230 of the photo manager 200. In another preferred embodiment, as shown in FIG. 2, the photo manager 200 displays the size (3.50″×2.50″) 510 of the photo box 120 through which the photo manager 200 is accessed. However, it will be recognized that in preferred embodiments of the present invention, the user is provided with the option of changing the size of the photo box 120.

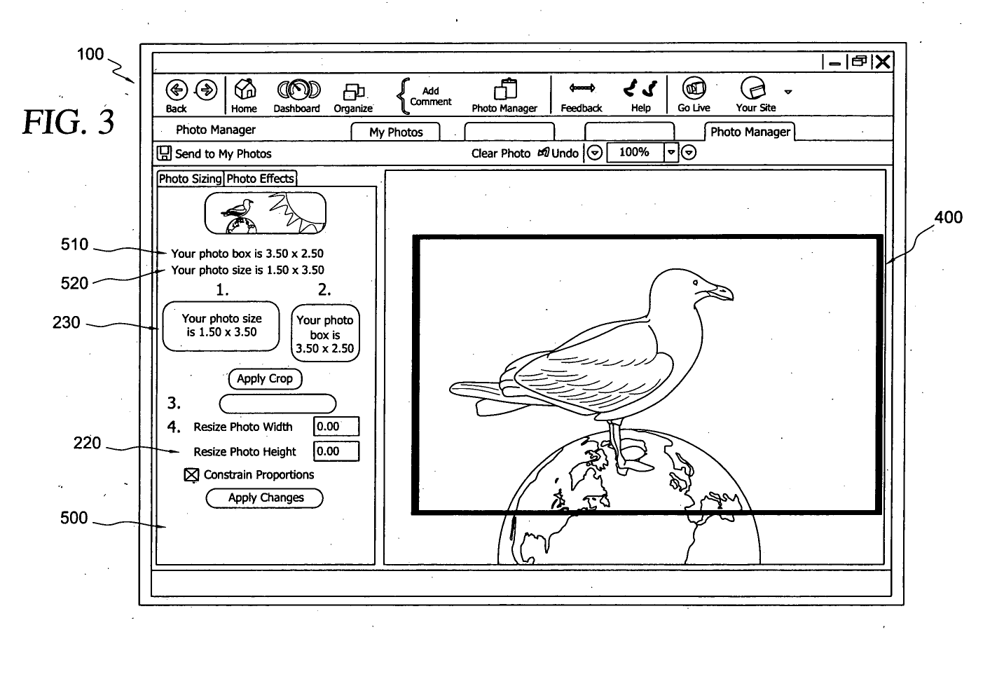

As illustrated in FIG. 3, an interface 100 provides access to the photo manager 200, wherein a photo has been loaded and displayed within the main photo area 400. In one preferred embodiment, when the photo is displayed in the main photo area 400, the tool area 500 displays both the size (3.50″×2.50″) 510 of the photo box 120 and the actual size of the photo (10.00″×6.00″) 520. Those of ordinary skill in the art will recognize that displaying the actual size of the photo and the photo box 120 will aid the user in composing, sizing or resizing, cropping and/or displaying the photo, that is, in managing the photo.

As illustrated in FIG. 4, an interface 100 provides access to the photo manager 200, wherein the image editor 210 has been superimposed over the photo. Those of ordinary skill in the art will recognize that a variety of techniques may be employed to launch and superimpose the image editor 210. In one preferred embodiment, the image editor 210 may be launched through the use of the controls 1, 2, 3, 4 located within the tool area 500 of the photo manager 200. For example, as shown in FIG. 4, the user may click on control 1, thereby launching and superimposing the image editor 210 on the photo displayed in the main photo area 400. In this example, and preferably, the defined boundary 310 of the image editor 210 is the same size as the size (3.50″×2.50″) of the photo box 120 through which the photo manager 200 is accessed. Those of ordinary skill in the art will recognize that because the defined boundary 310 of the image editor 210 is preferably launched having the same size as the photo box 120, the user is provided with the opportunity to manage a photo of the same size as will eventually be displayed within photo box 120 of the layout 110. Furthermore, because the image editor 210 may be preferably moved, so that the defined boundary 310 of the image editor 210 encompasses a different section(s) of the photo, the user may select the section(s) of photo that appear within the photo box 120 of the layout 110.

As illustrated in FIG. 5, an interface 100 provides access to the photo manager 200, including the superimposable and movable image editor 210. As discussed above, the image editor 210 is preferably movable, so that the defined boundary 310 of the image editor 210 encompasses almost any desired section of the photo displayed within the main photo area 400. Those of ordinary skill in the art will recognize that a number of tools for moving the image editor 210 may be provided for the user, for instance a computer mouse, a computer keyboard and so on. In this example, as shown in FIG. 5, the image editor 210 has been moved in an attempt to fit the seagull's head, as large as possible, within the defined boundary 310 of the image editor 210.

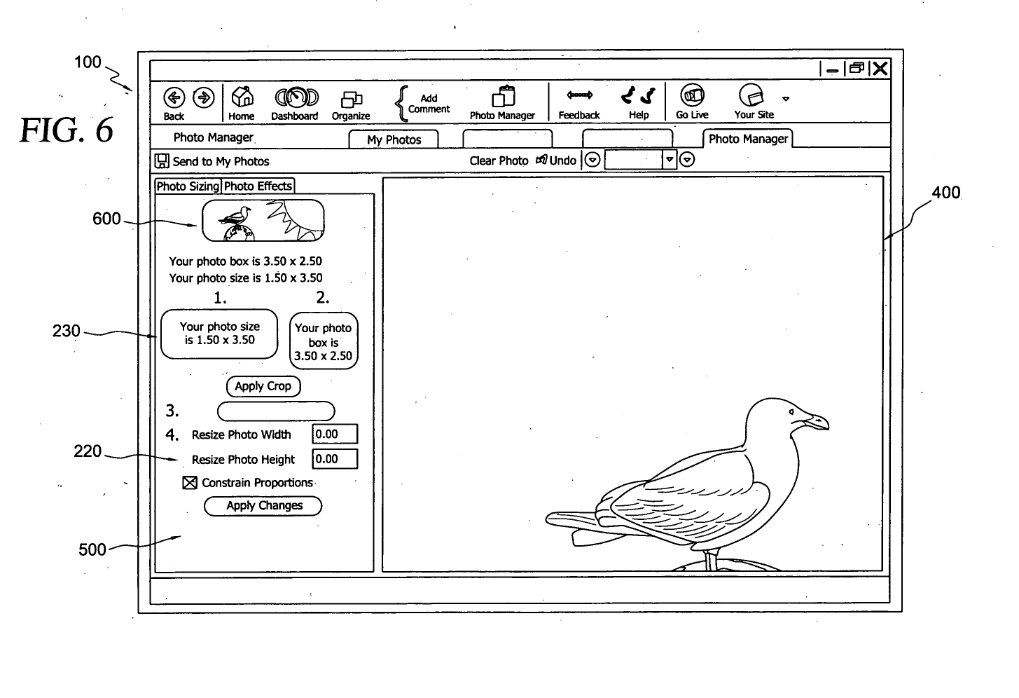

As illustrated by FIG. 6, an interface 100 provides access to the photo manager 200, including the photo crop tool 230. Those of ordinary skill in the art will recognize that, in accordance with the preferred embodiments of the present invention, whether before or after resize of the photo, the photo crop tool 230 may be used to crop the photo as defined by the boundary 310 of the image editor 210. In other words, the photo may be cropped so that only the section within the defined boundary 310 remains. In this example, the photo crop tool 230 is controlled via the tools located in the tool area 500; that is, the user clicks on the control labeled “Apply Crop”. As a result, the photo is cropped so that only the section of the photo within the defined by the boundary 310 of the image editor 210 is displayed within the photo manager 200. In sum, the user has composed the photo to include the seagull's head and cropped the photo to the same size (3.50″×2.50″) as the photo box 120. Preferably, the photo manager 200 also allows the user to save and place the composed and cropped (and possible resized) photo within the photo box 120 of the layout. That is, as further shown in FIG. 6, the user is preferably provided with a save tool 600, so that the photo is saved and/or placed within the photo box 120 of the layout 110. In this example, the user preferably selects the save tool (“Save and Place in Photo Box”) 600 and, as a result, the cropped photo is placed within the photo box 120 of the layout 110.

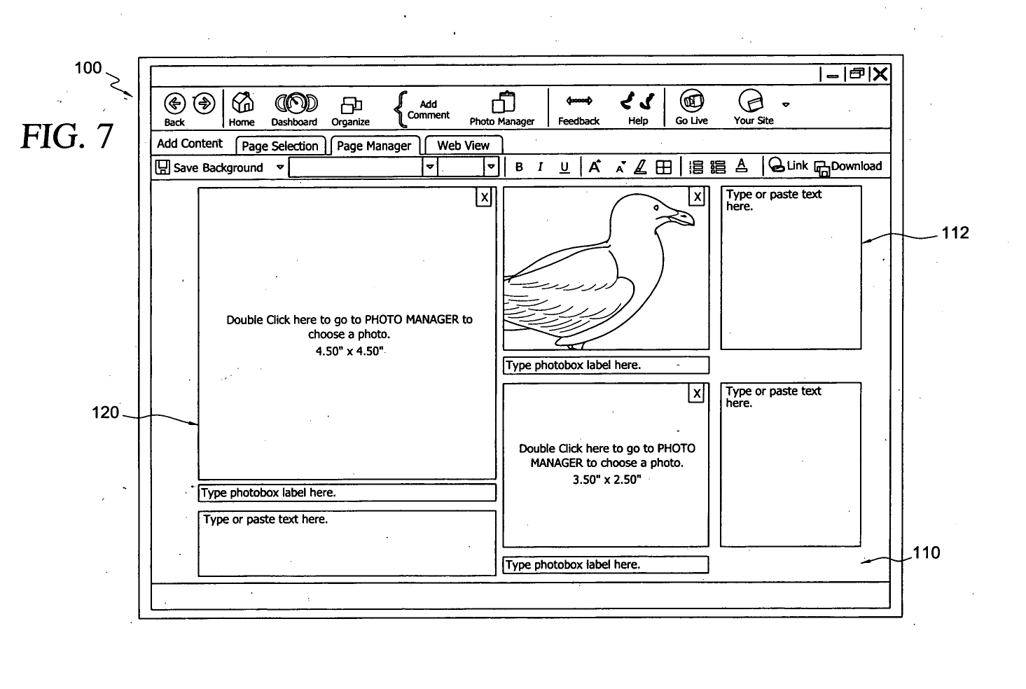

As illustrated by FIG. 7, an interface 100 provides access to the photo manager 200, wherein the cropped photo of FIG. 6 is displayed in the main photo area 400. In this example, after selecting the save tool (“Save and Place in Photo Box”) 600 as illustrated in FIG. 6, the photo was placed within the photo box 120 of the layout 110. With reference to both FIGS. 6 and FIG. 7, those of ordinary skill in the art will recognize that the photo has been cropped to the size and section defined by the boundary 310 of the image editor 210. As a result, the photo has been sized to fit precisely within the photo box 120 of the layout 110 of FIG. 1 (now shown in FIG. 7).

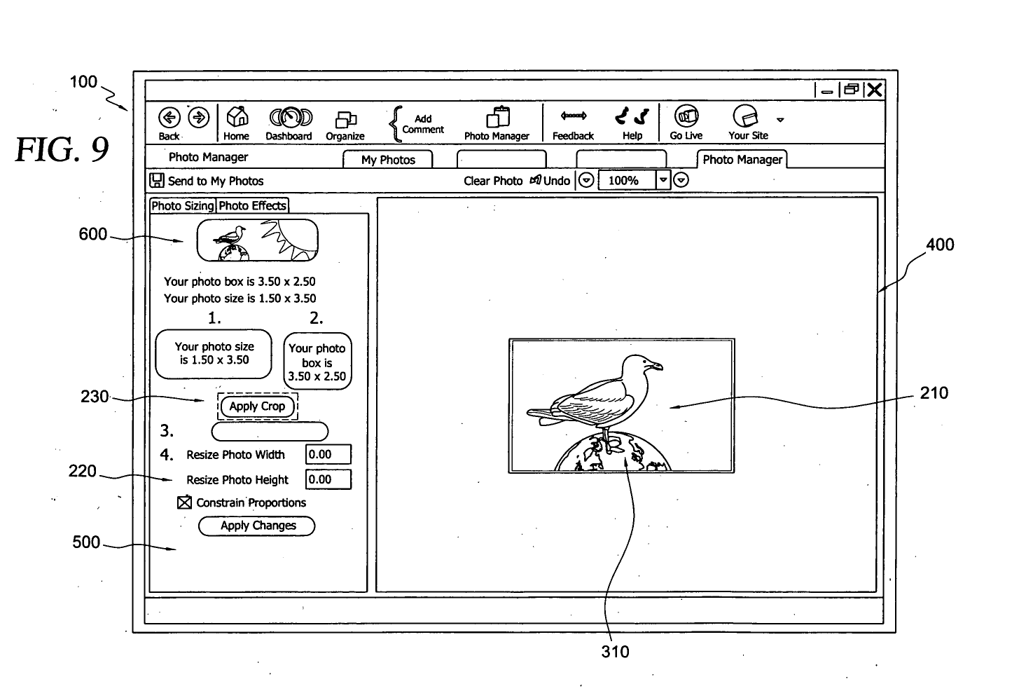

As illustrated in FIGS. 8 and 9, an interface 100 provides access to the photo manager 200, preferably also including the resize tool 220. In one preferred example, as shown in FIG. 8, the resize tool 220 may be operated though the resize control 4 located within the tool area 500 of the photo manager 200. Those of ordinary skill in the art will recognize that the resize control 4 may allow resizing of the photo displayed in the main photo area 400 to a variety of widths and heights as desired. For example, as shown in FIG. 9, the photo has been reduced in size from 10.00″×6.00″ to 6″×2.99″, in an attempt to fit more of the seagull within the defined boundary 310 of the image editor 210. As also shown in FIG. 9, although the resize tool 220 may not necessarily resize the photo so as to fit the entire photo within the defined boundary 310 of the image editor 210, much more of the photo does fit. Furthermore, if so desired, the user may again move the image editor 210 over the photo so as to fit more of the seagull within the defined boundary 310. Accordingly, those of ordinary skill in the art will recognize that the resize tool 220 may be used to vary the size of a photo, so as to better fit the photo and/or a desired section of a photo within the defined boundary 310 of the image editor 210.

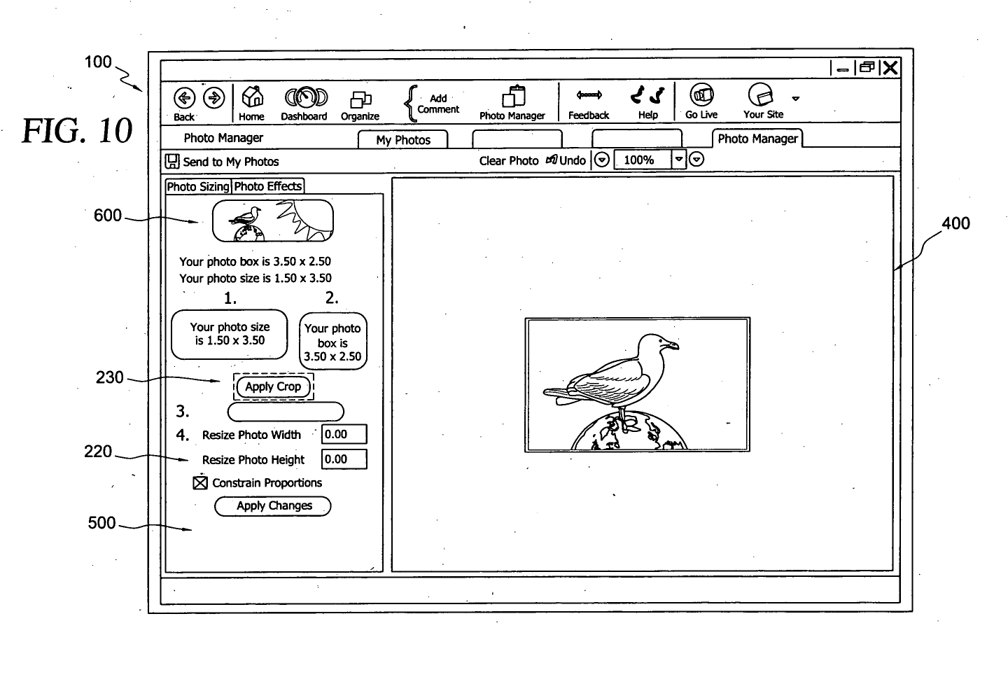

As illustrated by FIG. 10, an interface 100 provides access to the photo manager 200, including the photo crop tool 230. Those of ordinary skill in the art will recognize that, in accordance with the preferred embodiments of the present invention, the photo crop tool 230 may be used to crop the photo as defined by the boundary 310 of the image editor 210. In other words, the photo may be cropped so that only the section within the defined boundary 310 remains. In this example, the photo has been resized as illustrated in FIGS. 8 and 9, and then the photo crop tool 230 applied via the tools located in the tool area 500; that is, the user clicks on the control labeled “Apply Crop”. As a result, the photo is cropped so that only the section of the photo within the defined by the boundary 310 of the image editor 210 is displayed within the photo manager 200. In sum, the user has composed and resized the photo so that the entire seagull fits within the defined boundary 310 of the image editor 210, and then cropped the photo to the same size (3.50″×2.50″) as the defined boundary 310 (and photo box 120). Preferably, the photo manager 200 also allows the user to save and place the composed, resized and cropped photo within the photo box 120 of the layout. That is, as further shown in FIG. 10, the user is preferably provided with a save tool 600, so that the photo is saved and/or placed within the photo box 120 of the layout 110. In this example, the user preferably selects the save tool (“Save and Place in Photo Box”) 600 and, as a result, the cropped photo is placed within the photo box 120 of the layout 110.

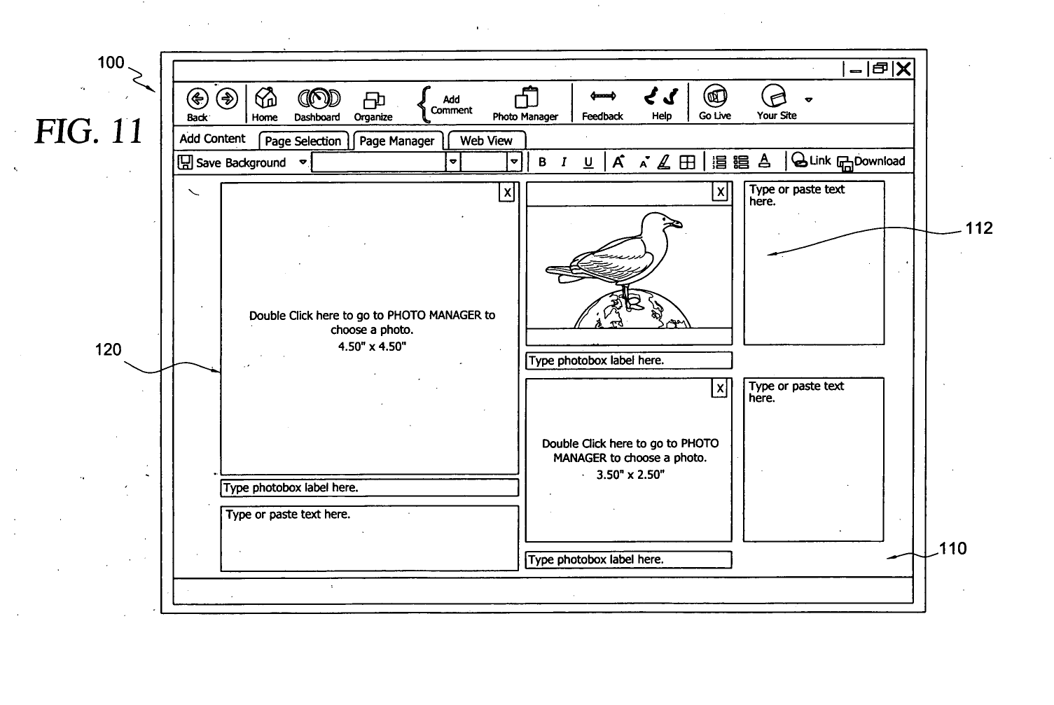

As illustrated by FIG. 11, an interface 100 provides access to the layout 110 of FIG. 1, wherein the resized and cropped photo is displayed within the photo box 120 of the layout 110. As shown in FIG. 11, those of ordinary skill in the art will recognize that the photo has now been composed, resized and cropped to fit precisely within the photo box 120. Those of ordinary skill in the art will also recognize that by clicking on the photo (e.g., with a computer mouse), the photo manager 200 may again be accessed with the photo displayed therein for further editing. Such editing may include editing with photo management tools, in accordance with the photo management capabilities of the photo manager 200. Furthermore, those of ordinary skill in the art will recognize that a different photo box may be selected, wherein the photo manager 200 is again accessed for the management of other photos.

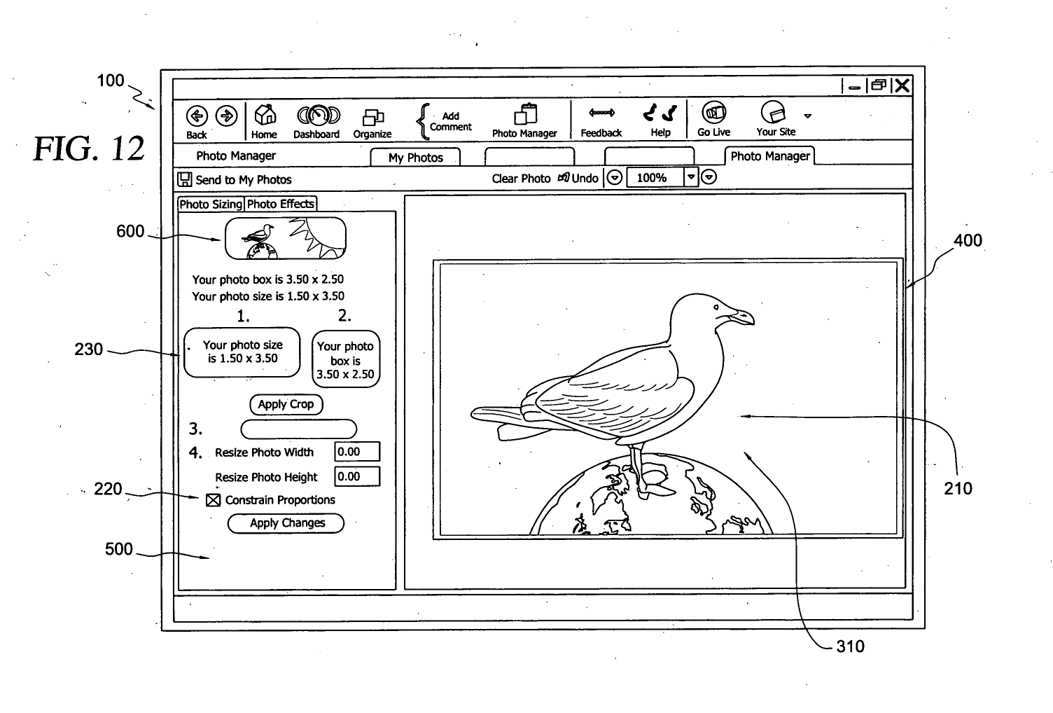

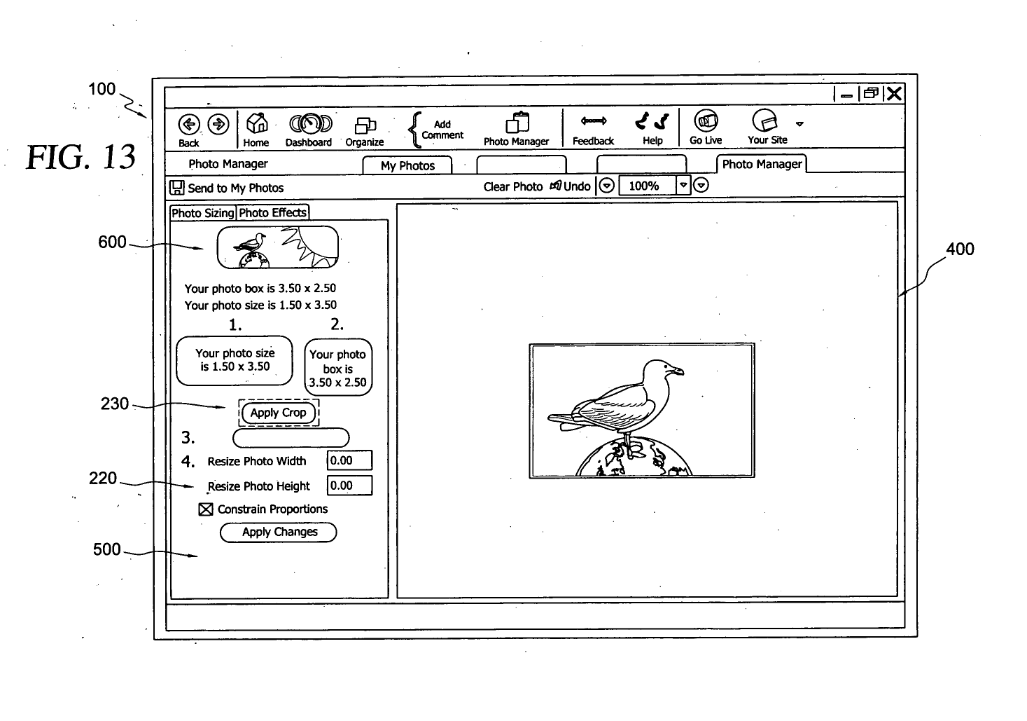

As illustrated in FIGS. 12 and 13, an interface 100 provides access to the photo manager 200, including the image editor 210, resize tool 220 and crop tool 230. In this example, however, in accordance with preferred embodiments of the present invention, the user has selected the tool 3 labeled “Fit Photo in Box”. Those of ordinary skill in the art will recognize that this tool allows the user to fit the entire photo within the defined boundary 310 of the photo box 120. Put another way, in this example, the photo manager 200 was accessed via a photo box 120 having a particular size, in this instance 3.50″×2.50″. The image editor 210 was then launched with a defined boundary 310 of the same size as the photo box, 120. Finally, without any composing or resizing of the photo, the tool 3 is employed to fit the entire photo within the defined boundary 310 of the image editor 210. In sum, the photo was managed so as to have the same size as the photo box 120

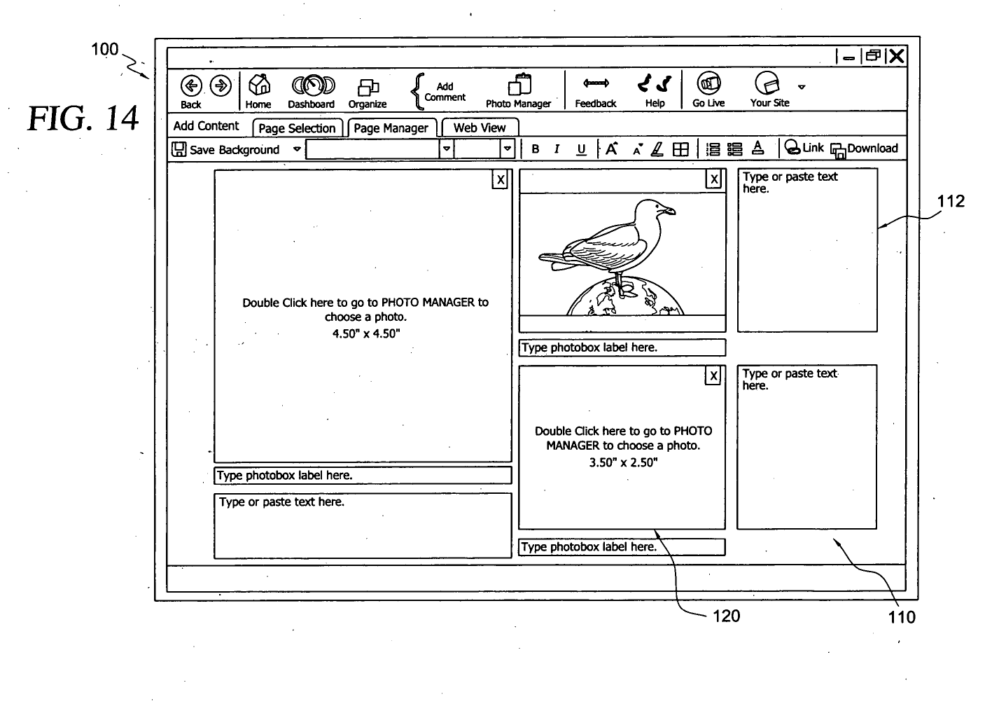

As illustrated by FIG. 14, an interface 100 provides access to the layout 110 of FIG. 1, wherein the managed photo of FIGS. 12 and 13 is displayed within the photo box 120 of the layout 110. That is, after selecting the tool (“Save and Place in Photo Box”) as shown in FIG. 13, the photo was saved and/or placed within the photo box 120 of the layout 110. Those of ordinary skill in the art will recognize that the managed photo of FIGS. 12 and 13 fits precisely within the photo box 120. Those of ordinary skill in the art will also recognize that by clicking on the photo (e.g., with a computer mouse), the photo manager 200 may again be accessed with the photo displayed therein for further editing. Such editing may include editing with photo management tools, in accordance with the photo management capabilities of the photo manager 200. Furthermore, those of ordinary skill in the art will recognize that a different photo box may be selected, wherein the photo manager 200 is again accessed for the management of other photos.

Those of ordinary skill in the art will recognize that the preferred embodiments of the present invention encompass the publication of the layout 110 including photos displayed therein. For example, in one preferred embodiment, the present invention includes tools for publishing the layout 110 to the Internet, as a web page or part of a web page. Such publication tools are well within the skill of those of ordinary skill in the art. In another preferred embodiment, the present invention includes tools for formatting the layout 110 with photos for printing with a printer. Those of ordinary skill in the art will recognize that any number of publication and display options that may be encompassed by the present invention.

Those of ordinary skill in the art will also recognize, especially in view of FIGS. 1, 7, 11 and 14 that the interface 100 preferably provides the user with what is known in the art as What You See Is What You Get (“WYSWYG”). That is, the interface 100 (e.g., the Page Manger of the interface 110) preferably provides the user with a view of the page as it would appear if finished or published at that moment, even though the page remains under construction. In other words, in accordance with preferred embodiments of the present invention, the user is preferably provided with a view of the page as it would appear if published at the moment, as shown for instance in FIGS. 1, 7, 11 and 14, without having to actually undergo additional steps such as publication as typically required. Those of ordinary skill in the art will recognize that such WYSWYG capability greatly simplifies the process of a building a page such as a web page.

Technical Design Overview

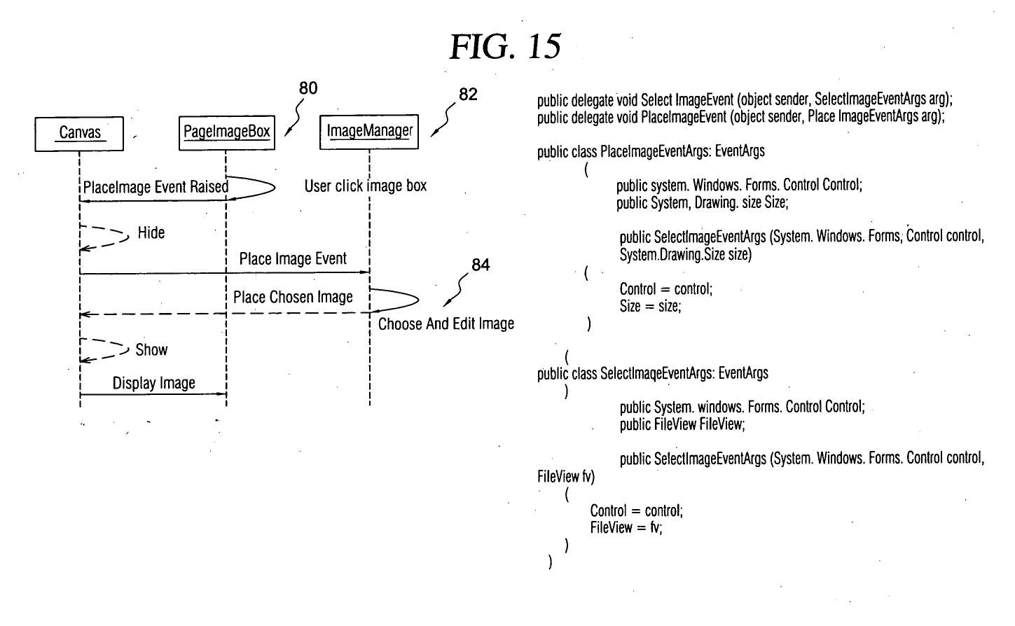

With respect to the technical design of systems, methods and computer software programs, the present invention may employ any number of preferred embodiments. For example, those of ordinary skill in the art will recognize FIG. 15 as illustrating a technical design 80 in accordance with exemplary embodiments of the present invention.

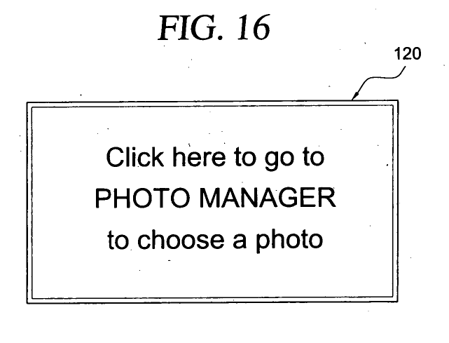

With reference to FIG. 15, those of ordinary skill in the art will recognize that in addition to being an image editor 84, the ImageManager 82 preferably acts as an Image Chooser 84. This type of event is preferably fired when the user clicks on an ImageBox (e.g., a photo box 120) from either a DirectoryManager's Directory Listing Control (not shown) or a Page Manager's Imagecontrol (not shown). For example, as described throughout this application, there is provided an ImageBox (e.g., a photo box 120) as shown in FIG. 16. When this box 120 is clicked, a SelectImage event is raised from each of the controls, as those of ordinary skill in the art will recognize from the illustrated instructions of FIG. 15. The event is bubbled up to the MainForm. At this point, the current manager is hidden and ImageManager 82 becomes active and placed into the “PlacingImage” state, as those of ordinary skill in the art will also recognize from the illustrated instructions of FIG. 15. Preferably, the SelectImage event contains the sender control and size of the ImageBox 120. The ImageBox 120 size is preferably passed on to ImageManager 82. Extra functions are preferably added (e.g., to the controls for the cropping tool 230), such as:

allowing the user to apply a crop of the selected size,

display of the image editor 210 size,

allowing the user to save the image and return to the previous manager.

Those of ordinary skill in the art will further recognize that the systems, methods and computer software instructions illustrated above may be contained as a utility, program, subprogram, in any desired computer accessible medium. In addition, the present invention may be embodied by a computer program or a plurality of computer programs, which may exist in a variety of forms both active and inactive in a single computer system or across multiple computer systems. For example, they may exist as software program(s) comprised of program instructions in source code, object code, executable code or other formats for performing some of the steps. Any of the above may be embodied on a computer readable medium, which include storage devices and signals, in compressed or uncompressed form.

Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated below may be performed by any electronic device capable of executing the above-described functions.

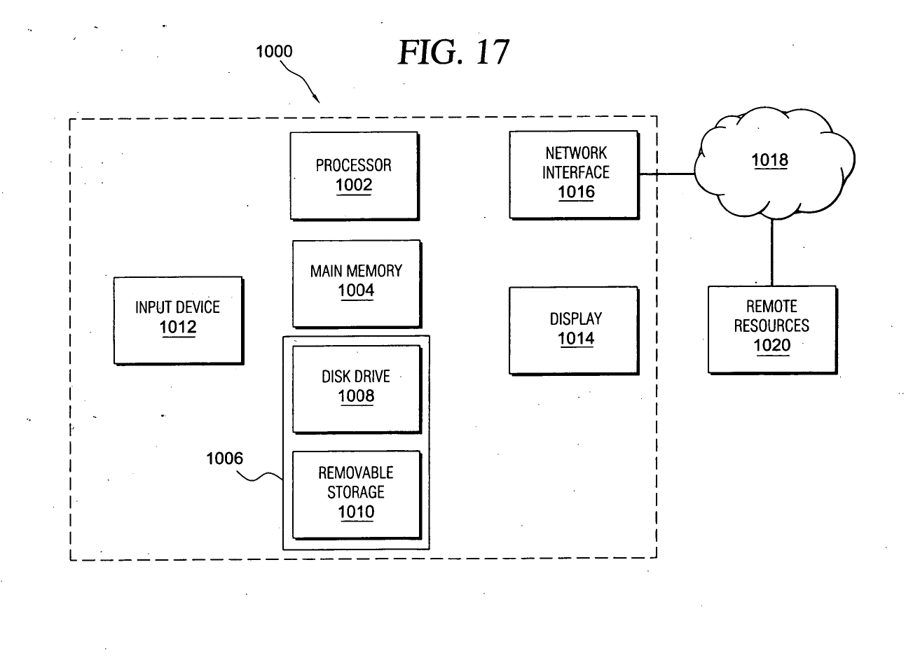

FIG. 17 illustrates an exemplary block diagram of a computer system 1000 that may implement the interfaces and the methods shown in FIGS. 1 - 16. The computer system 1000 includes one or more processors, such as processor 1002, providing an execution platform for executing software. The processor 1002 may also execute an operating system (not shown) for executing the software in addition to performing operating system tasks.

The computer system 1000 also includes a main memory 1004, such as a Random Access Memory (RAM), providing storage for executing software during runtime and mass storage 1006. The mass storage 1006 may include a hard disk drive 1008 and/or a removable storage drive 1010, representing a floppy diskette drive, a magnetic tape drive, a compact disk drive, or a nonvolatile memory where a copy of software or data may be stored. Applications and resources may be stored in the mass memory 1006 and transferred to the main memory during run time. The mass memory 1006 may also include ROM (read only memory), EPROM (erasable, programmable ROM), EEPROM (electrically erasable, programmable ROM).

A user interfaces with the computer system 1000 with one or more input devices 1012, such as a keyboard, a mouse, a stylus, or any other input device and views results through a display 1014. A network interface 1016 is provided for communicating through a network 1018 with remote resources 1020. The remote resources 1020 may include servers, remote storage devices, data warehouses, or any other remote device capable of interacting with the computer system 1000.

What has been described and illustrated herein are examples of the systems and methods described herein along with some of their variations. The terms, descriptions and figures used herein are set forth by way of illustration only and are not meant as limitations. Those skilled in the art will recognize that many variations are possible within the spirit and scope of these examples, which intended to be defined by the following claims and their equivalents in which all terms are meant in their broadest reasonable sense unless otherwise indicated.

What is claimed is:

1. A method of managing photos, comprising:
providing a user interface comprising a photo manager, the photo manager comprising an image editor, the image editor having a defined boundary;
superimposing the image editor over at least a section of a photo; and
resizing at least a portion of the photo within the defined boundary of the image editor.

2. The method of claim 1, further comprising moving the image editor over the photo so that a desired section of the photo rests within the defined boundary of the image editor.

3. The method of claim 1, further comprising cropping the photo as defined by the boundary of the image editor.

4. The method of claim 1, further comprising cropping the photo after resizing the photo.

5. The method of claim 1, further comprising providing a user interface for providing the user with at least one layout, wherein the layout is customizable by the user.

6. The method of claim 1, further comprising providing a user interface for providing the user with at least one layout, wherein the layout comprises at least one photo box for placement of the photo.

7. The method of claim 6, further comprising accessing the photo manager via the photo box.

8. The method of claim 6, wherein the photo box contains a photo resized or cropped by the photo manager.

9. The method of claim 1, further comprising providing a user interface for providing the user with the photo manager.

10. A photo management system, said photo management system comprising:
a photo manager comprising an image editor and a resize tool;
the image editor having a defined boundary and superimposable over a photo; and
a resize tool providing for resizing at least a section of the photo within the defined boundary of the image editor.

11. The photo management system of claim 10, wherein the image editor is movable over the photo so that a desired section of the photo rests within the defined boundary of the image editor.

12. The photo management system of claim 10, further comprising a cropping tool for cropping the photo as defined by the boundary of the image editor.

13. The photo management system of claim 12, wherein the photo is cropped before or after the photo is resized.

14. The photo management system of claim 10, further comprising a user interface for providing the user with at least one layout, wherein the layout is customizable by the user.

15. The photo management system of claim 10, further comprising a user interface for providing the user with at least one layout, wherein the layout comprises at least one photo box for placement of the photo.

16. The photo management system of claim 15, wherein the photo manager is accessible via the photo box.

17. The photo management system of claim 15, wherein the photo box contains a photo resized or cropped by the photo manager.

18. The photo management system of claim 10, further comprising a user interface for providing the user with the photo manager.

19. A computer readable storage medium on which is embedded one or more computer programs, the one or more computer programs implementing a method for managing photos, the one or more computer programs comprising a set of instructions for:
providing a user interface comprising a photo manager, the photo manager comprising an image editor, the image editor having a defined boundary;
superimposing the image editor over at least a portion of a photo; and
resizing at least a section of the photo within the defined boundary of the image editor.

20. The computer readable storage medium of claim 19, further comprising moving the image editor over the photo so that a desired section of the photo rests within the defined boundary of the image editor.

21. The computer readable storage medium of claim 19, further comprising cropping the photo as defined by the boundary of the image editor.

22. The computer readable storage medium of claim 21, further comprising cropping the photo before resizing the photo.

23. The computer readable storage medium of claim 21, further comprising cropping the photo after resizing the photo.

24. The computer readable storage medium of claim 19, further comprising a user interface for providing the user with at least one layout, wherein the layout is customizable by the user.

25. The computer readable storage medium of claim 19, further comprising providing a user interface for providing the user with a layout, wherein the layout comprises at least one photo box for the placement of at least one photo.

26. The computer readable storage medium of claim 25, wherein the photo manager is accessible via said photo box.

27. A photo management system, said system comprising:
a first user interface for providing the user with a layout, wherein said layout comprises at least one photo box for the placement of at least one photo;
a second user interface for providing the user with a photo manager, wherein said photo manager is accessible via said photo box.

28. The photo management system of claim 27, further comprising:
the photo manager comprising an image editor;
the image editor having a defined boundary and superimposable over a photo; and
a resize tool providing for resizing at least a section of the photo within the defined boundary of the image editor.

29. The photo management system of claim 28, further comprising:
the image editor movable over the photo so that a desired section of the photo rests within the defined boundary of the image editor.

30. The photo management system of claim 28, further comprising:
a cropping tool for cropping the photo as defined by the boundary of the image editor.

31. The photo management system of claim 27, wherein the layout is customizable by the user.

32. A method of managing photos, said method comprising:
providing a user interface comprising a layout, wherein said layout comprises at least one photo box for the placement of at least one photo;
accessing a photo manager via said photo box;
providing the photo manager within a user interface.

33. The method of claim 32, further comprising:
the photo manager comprising an image editor, the image editor having a defined boundary;
superimposing the image editor over at least a portion of a photo; and
resizing at least a section of the photo within the defined boundary of the image editor.

34. The method of claim 33, further comprising moving the image editor over the photo so that a desired section of the photo rests within the defined boundary of the image editor.

35. The method of claim 33, further comprising:
cropping the photo as defined by the boundary of the image editor.

36. The method of claim 32, wherein the layout is customizable by the user.
